(19) United States
(12) Patent Application Publication
(10) Pub. No.: US 2007/0004465 A1
(43) Pub. Date: Jan. 4, 2007

(54) Pilot Channel Design for Communication Systems

(76) Inventors: Aris Papasakellariou, Dallas, TX (US); Timothy M. Schmidl, Dallas, TX (US); Eko N. Onggosanusi, Allen, TX (US); Anand G. Dabak, Plano, TX (US); Tarik Muharemovic, Dallas, TX (US)

Correspondence Address: TEXAS INSTRUMENTS INCORPORATED, P O BOX 655474, M/S 3999, DALLAS, TX, 75265, US

(21) Appl. No.: 11/427,682

(22) Filed: Jun. 29, 2006

Related U.S. Application Data
(60) Provisional application No. 60/695,773, filed on Jun. 29, 2005.

(51) Int. Cl. H04B 1/38; H04B 1/04; H01Q 11/12; H04M 1/00

(52) U.S. Cl. 455/571; 455/127.1

(57) ABSTRACT

Embodiments of the invention provide method and structure for boosting pilot signal power relative to data signal power. The velocity of user equipment is obtained. The velocity measurement is used in determining the transmission power of the pilot signal and applying the increase to a plurality of pilots and decreasing the data signal power by a proportional amount.

### CLAIM OF PRIORITY UNDER 35 U.S.C. §119

The present Application for Patent claims priority to 60/695,773 entitled “Pilot channel design for single-carrier uplink systems” filed Jun. 29, 2005, Said application is assigned to the assignee hereof and is hereby incorporated by reference.

### BACKGROUND

Embodiments of the invention are directed, in general, to communication systems and, more specifically, to pilot channel design used in communications systems.

Support of wide area coverage is one of the most important aspects in all cellular systems. Single-Carrier Frequency Division Multiple Access (SC-FDMA) provides a peak-to-average power ratio (PAPR) that is inherently lower than multi-carrier based radio access such as Orthogonal Frequency Division Multiple Access (OFDMA). While PAPR is not as important in the downlink (DL), that is the communication from a base station (BS) (or Node B) to user equipments (UE), where the BS is not power limited and OFDMA signal orthogonality outweighs the lower PAPR benefit of single-carrier transmission and can provide higher data rates in high received signal-to-interference plus noise ratio (SINR) regions, low PAPR is very advantageous in the uplink (UL), that is the communication from UEs to BS, for enabling low UE power consumption and better power amplifier efficiency and signal coverage. Although PAPR-reducing methods can be applied to OFDM-based transmission schemes, such methods come at the expense of additional UE complexity as well as reduced performance due to reduced spectral utilization and/or signal corruption.

There is a need for a transmission scheme which can increase performance of the communication system without increasing user equipment complexity.

### SUMMARY

In light of the foregoing background, embodiments of the invention provide a method and structure for boosting pilot signal power relative to data signal power. The velocity of user equipment is obtained. The velocity measurement is used in determining the transmission power of the pilot signal and applying the increase to a plurality of pilots and decreasing the data signal power by a proportional amount.

Therefore, the system and method of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1A is a diagram illustrative of using cyclic prefix to perform frequency domain equalization;

FIG. 1B two pilot fields each having 128 samples per TT;

FIG. 1C three pilot fields each having 80 samples per TTI;

FIG. 2 shows frequency diversity with D-FDMA and multiuser diversity with frequency domain scheduling and L-FDMA;

FIG. 3 shows frequency diversity and multi-User diversity concepts;

FIG. 4 is a diagram illustrative of resource blocks and multiplexing;

FIG. 5 is a diagram illustrative of the generation of SC-FDMA (IFDMA) Signals in Time Domain;

FIG. 6 is a diagram illustrative generation of SC-FDMA (IFDMA) Signals in Frequency Domain;

FIG. 7 is a diagram illustrative of a transmitter structure of DFT-spread SC-FDMA with pulse shaping in time domain in accordance with embodiments of the invention;

FIG. 8 shows mapping relations between FFT and IFFT for localized and distributed FDMA;

FIG. 9 is a diagram illustrative of a transmitter of DFT-spread SC-FDMA with pulse shaping in frequency domain;

FIG. 10 is a diagram showing sub-frame format with two short blocks and six long blocks per a sub-frame;

FIG. 11 shows frequency-domain staggering of the pilot signals of SB2, relative to SB1;

FIG. 12 shows continuous pilot signals in the frequency domain;

FIG. 13 is diagram illustrative of a structure (L-FDMA, D-FDMA) of SBs (pilot) and LBs (data) for performance evaluation of pilot power boosting;

FIG. 14 is a graph showing BLER performance with different values of pilot boosting for UE speed of 3 Kmph. Transmit Power Boost is Applied Only to SB1. QAM16 modulation;

FIG. 15 is a graph showing BLER performance with different values of pilot boosting for UE speed of 120 Kmph. Transmit Power Boost is Applied Only to SB1. QAM16 modulation; and

FIG. 16 is a graph showing BLER performance with different values of pilot boosting for UE speed of 360 Kmph. Transmit Power Boost is Applied Only to SB1. QAM16 modulation.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

One or more transmitters each corresponding to particular user, communicate with one or more receivers by way of a communication channel.

Multiple users can simultaneously transmit data over the channel. The transmitters and receivers may be mobile subscriber units, such as mobile phones, PDA, pagers, laptops computers with wireless equipment and the like. They may also be fixed as base stations. The transmitters and receivers may include suitable combinations of hardware and/or software components for implementing the modulation scheme of embodiments the invention.

In a single-carrier communication system, pilot symbols are transmitted in addition to data symbols in order to serve, among others, in providing a reference for the receiver to estimate the channel medium and accordingly demodulate the received signal. The scheme proposed in this disclosure is applicable to any single-carrier FDMA schemes such as interleaved FDMA (IFDMA), localized FDMA, and DFT-spread OFDMA. It also applies to general single-carrier systems. A TDM-based pilot channel structure is considered for the uplink of a single-carrier FDMA system because it achieves a lower peak-to-average ratio (PAPR) than an FDM or a CDM structure. Also, unlike CDM, a TDM pilot structure can completely avoid interference which enables accurate channel estimation particularly in MIMO multiplexing/diversity.

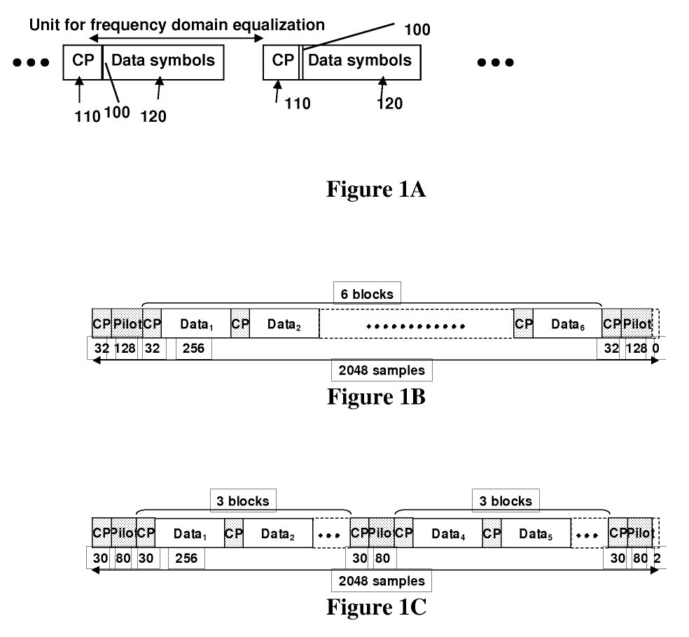

FIG. 1A is a model diagram illustrative of using data blocks 100 each comprising cyclic prefix 110 coupled to data symbols 120 to perform frequency domain equalization. SC-FDMA allows the application of simple frequency domain equalization (FDE) through the use of a cyclic prefix (CP) 110 at every FFT processing block 100 to suppress multi-path interference. Two blocks are shown for drawing convenience. CP 110 eliminates inter-data-block interference and multi-access interference using FDMA.

Embodiments of the invention optimize the pilot overhead, and thereby optimize the overall network performance. This is accomplished while maintaining the simplicity of a single TTI format and avoiding the need for additional uplink signaling from each mobile (user equipment or UE) associated with informing the base station about changes in the TTI format associated with changes in the number or positions of pilot fields or number of samples per pilot field as a function of the UE velocity. UE in accordance with embodiments of the invention include, inter alia, storage for storing predetermined power values and a doppler estimator for estimating the velocity of the UE. At low velocities, good channel estimates can be obtained with a smaller pilot power overhead than at high velocities. UE also comprises data signal power and pilot signal power adjustors embodiments of which are described in the various figures to follow.

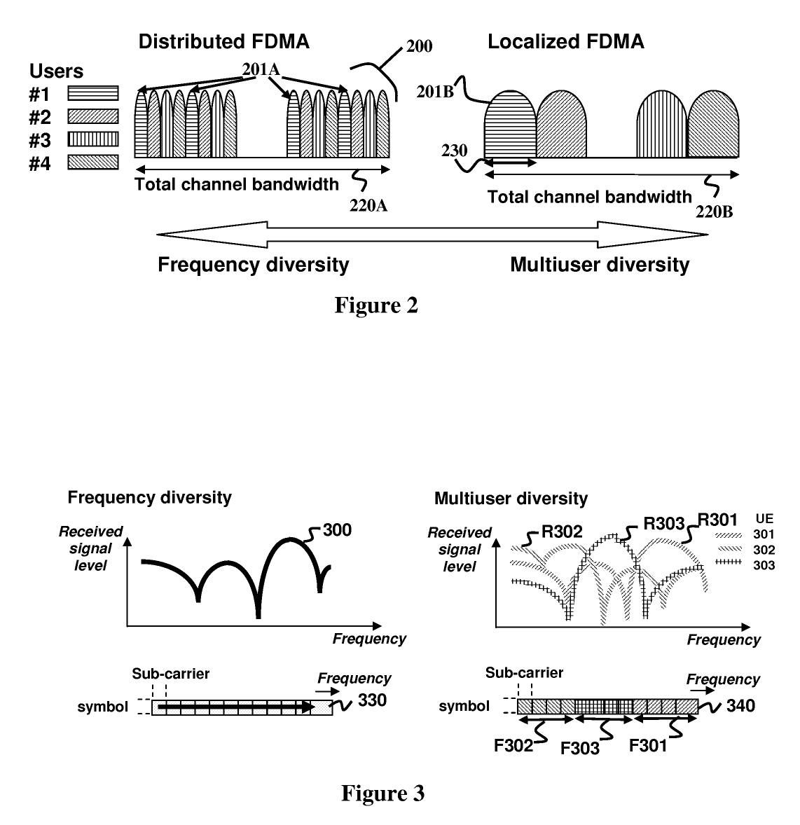

Two exemplary TDM pilot structures for a transmission time interval (TTI) are given in FIGS. 1B and 2C, where CP denotes the cyclic prefix. The figures show actual application of the model shown in FIG. 1A, wherein different pilot positions and number of samples can be applied in a TTI. It is therefore desirable for a given TTI format, such as those shown in the figures, to vary the power allocated to the pilot samples according to the UE velocity. In that manner, the desired quality of the channel estimate for each UE may be ensured while adaptively optimizing the power allocated to the pilot fields. Different power levels may be allocated to different pilot fields within a TTI while maintaining the same total power allocated to the pilot fields.

Orthogonality is employed among simultaneously accessing UEs in the frequency domain in addition to the time domain. With time domain packet scheduling of all physical channels and UL synchronization among the transmitting UEs, orthogonality among UEs in the time domain is achieved. Furthermore, orthogonality among UEs can be also achieved in the frequency domain through localized frequency division multiple access (L-FDMA) and Distributed FDMA (D-FDMA having a comb-shaped spectrum). Combination of L-FDMA and D-FDMA allows intra-cell interference avoidance.

FIG. 2 is an illustration depicting the D-FDMA and L-FDMA concepts. In Distributed FDMA, each user transmission may be distributed over total frequency bandwidth. D-FDMA contains repeated sequences of modulated data symbols that result in a comb-shaped spectrum typically covering the entire frequency band with equally spaced sub-carriers 200. D-FDMA uses frequency diversity to separate user transmissions. D-FDMA is subject to being sensitive to frequency errors. In Localized FDMA, each user transmission is localized in portion of the bandwidth. L-FDMA has reduced requirements for synchronization and is less sensitive to frequency errors. For example, User #1 transmission in D-FDMA is distributed in multiple transmissions 201A over total frequency bandwidth 220A. In L-FDMA, each User #1 transmission is localized 201B in portion 230 of the bandwidth 220B.

L-FDMA is beneficial for exploiting multi-user diversity in the frequency domain, since channel quality variations often occur over the frequency band. L-FDMA has a continuous spectrum. On the other hand, D-FDMA exploits frequency diversity in the radio channel and is preferable when there are no reliable channel quality indicator (CQI) estimates available for the BS scheduler or when transmissions are unscheduled such as the ones requiring low latency.

Referring now to FIG. 3 which is an illustration depicting frequency diversity 310 and multi-user diversity 320 concepts. As stated above, D-FDMA contains repeated sequences of modulated data symbols covering the entire frequency band with equally spaced sub-carriers 330. Different D-FDMA transmissions may be multiplexed by interleaving in frequency, having different frequency offsets. The sequences of modulated data symbols have sub-carriers 340 of frequency ranges assign to the UEs F301, F302, and F303 respectively. The interleaving allows the user equipment (UE) 301, 302, 303 to share the same received signal 300 with components R301, R302 and R303.

It is advantageous to allow for simultaneous L-FDMA and D-FDMA transmissions. For example, channels with low latency tolerance to be transmitted using D-FDMA while channels corresponding to high data rate applications may be transmitted using L-FDMA. Data multiplexing from different UEs is mainly controlled by the BS scheduler, which allocates time and frequency resources to each UE and decides whether L-FDMA or D-FDMA is used for the UE transmissions.

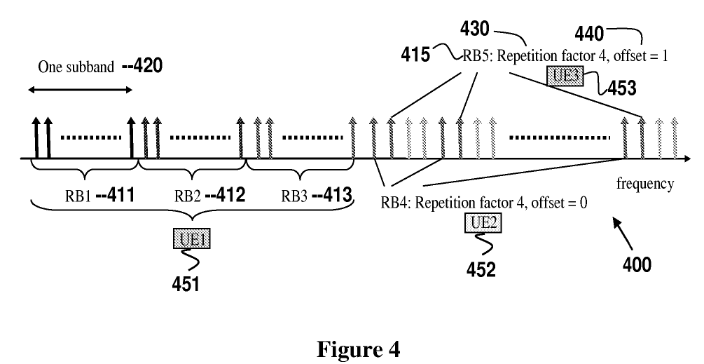

Referring now to FIG. 4, which is diagram illustrative of resource blocks and multiplexing. The UpLink (UL) bandwidth 400 is divided into sub-bands or resource blocks (RBs) of equal width 41x. An RB is the smallest resource unit to be used for transmission and may be either localized or distributed in nature. An RB for L-FDMA covers a continuous sub-band, such as 420 for RB1 411. An RB for D-FDMA is characterized by a repetition factor 430 and a frequency offset 440 in addition to the covered sub-band(s). In FIG. 4 for example, RB4 414 has repetition factor of 4 and frequency offset of 0 and RB5 415 has repetition factor of 4 and frequency offset of 1. Since D-FDMA a comb-shaped spectrum, several RBs with equal Repetition Factor (RF) but different frequency offsets occupy the same sub-band.

In order to keep the low PAPR of SC-FDMA, the UE can only perform either L-FDMA or D-FDMA transmission at a time and hence only one RB type can be used by a UE at a time. The transmission may however occupy several RBs of the same type. As shown in FIG. 4, RBs 411-413 are for L-FDMA transmissions and each covers a continuous sub-band 420. The remaining RBs are for D-FDMA transmissions. In FIG. 4, three UEs 45x are multiplexed: UE1 451 is allocated RBs 411-413 with L-FDMA while UE2 452 and UE3 453 are allocated RBs 414 and 415, respectively, with D-FDMA.

In case of L-FDMA transmission, the bandwidth of the pulse shaping filter changes in proportion to the symbol rate, (i.e. in proportion to the block size). Then, UE-specific phase rotation makes the L-FDMA signal move to a target RB region. In order to guarantee orthogonal access, there should be nearly no spectral overlap between the UEs' L-FDMA signals. However, in case of D-FDMA transmission, the pulse shaping filtering is typically applied over the whole band irrespective of the bandwidth of the transmitted D-FDMA signal. Orthogonality between different UEs' D-FDMA signals can be guaranteed by making different UEs' comb-fingers not overlap via UE-specific phase rotation. UE-specific phase rotation may also be applied after the block repetition. Both L-FDMA and D-FDMA transmissions may be realized based on a single identical transmitter structure.

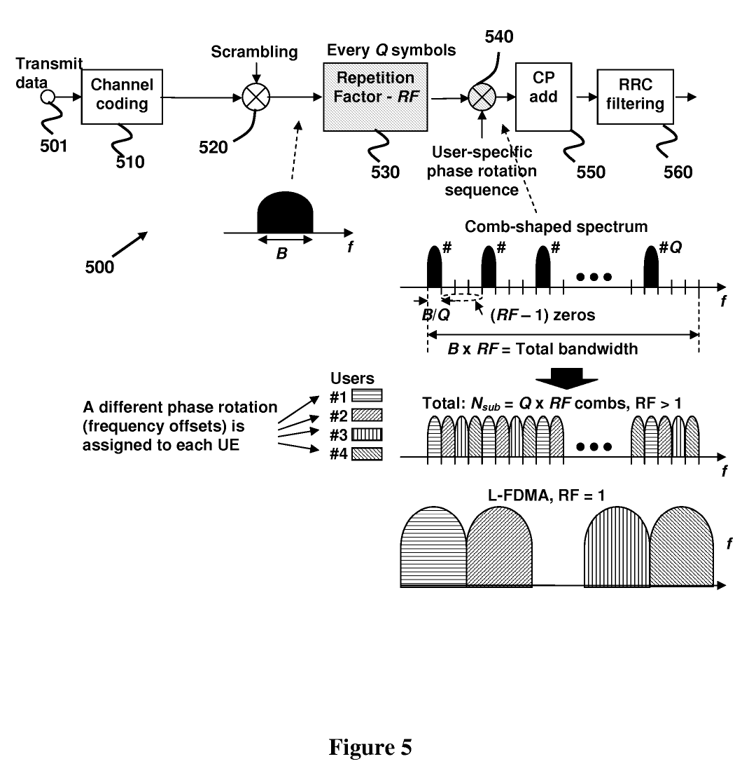

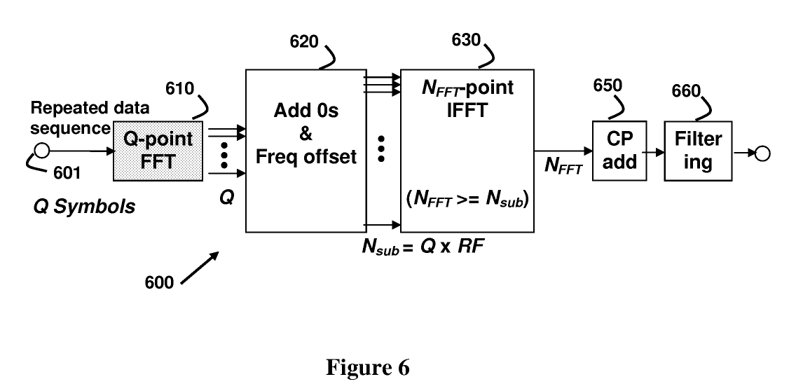

For wide channel bandwidths (for example, 5 MHz or more), the effective use of frequency diversity is beneficial while multi-user diversity in the frequency domain by frequency channel-dependent scheduling may provide additional gains. For frequency diversity, the total channel bandwidth (including distributed sub-carriers throughout the entire channel bandwidth) is utilized by employing interleaving of encoded bits or spreading over multiple sub-carriers. This is also known as interleaved FDMA or IFDMA. For multi-user diversity by channel-dependent scheduling, the channel bandwidth is segmented into multiple RBs in each transmission time interval (TTI), and channel-dependent scheduling in the frequency and time domain assigns these RBs to UEs based on their channel conditions. FIGS. 5 and 6 show, respectively, the generation of distributed and localized IFDMA signals in the time and frequency domain.

FIG. 5 is a diagram of an illustrative exemplary system for the generation of SC-FDMA (IFDMA) Signals in Time Domain. Signal generator 500 in accordance with embodiments of the invention comprise transmit data 501 is received by a channel coder 510, scrambling is applied with multiplier 520, symbol block repeator 530 for providing repetition factor, modulator 540 applying user-specific phrase rotation sequence 540, Cyclic Prefix (C/P) inserter 550, and an RRC filter 560.

With IFDMA, the baseband signal begins as a single-carrier phase shift keying (PSK) or quadrature amplitude modulation (QAM) symbol stream. The symbols are grouped into blocks which are repeated via repeater 530. The repetition of the symbol blocks causes the spectrum of transmitted signal to be non-zero only at certain sub-carrier frequencies.

The IFDMA transmissions remain orthogonal as long as: 1) they occupy different sets of sub-carriers, which is accomplished by IFDMA user-specific phase rotation sequences 540, 2) a cyclic extension (or guard period) such as that shown in FIGS. 1A to 1C is added to the transmission 550, where the cyclic extension is longer than the channel pulse response, and 3) the signals are synchronized with the receiver in time.

Thus, modulator 540 receives a symbol stream and an user-specific IFDMA modulation code. The output of modulator 540 comprises signal existing at certain frequencies, or sub-carriers. The actual sub-carriers that signal utilizes is dependent upon the repetition of the symbol blocks and the particular modulation code utilized. Thus, by changing the modulation code, the set of sub-carriers changes. It should be noted, however, that while changing will change the sub-carriers utilized for transmission, the evenly-spaced nature of the sub-carriers remain. Sub-carrier spacing (minimum frequency granularity) of comb-shaped D-FDMA signal or L-FDMA signal within the RB should be large enough so that the influence from phase noise and frequency drift is negligible. The sub-carrier spacing should optimize the tradeoff between increase in frequency diversity and avoidance of residual multi-user interference.

For time domain channel-dependent scheduling, a pilot signal needs to be transmitted by the scheduled UE only in the RBs assigned to that UE by the BS for UL transmission in order to allow for channel estimation and signal demodulation at the BS. D-FDMA with comb-shaped spectrum or L-FDMA may be used. Multi-user signals can be orthogonal in the frequency domain by using L-FDMA between the RBs and possibly further D-FDMA in the same RB.

FIG. 6 is a diagram illustrative generation of SC-FDMA (IFDMA) Signals in Frequency Domain. In system 600, Repeated data sequence (Q symbols) are operated on by Q-point Fast Fourier Transform (FFT) block 610, zero padding and frequency offsets are applied at block 620, an N_{FFT} point Inverse Fast Fourier Transform (IFFT) block, cyclic prefix is added 650 before filtering 660.

For frequency-time domain channel-dependent scheduling the pilot signal needs to be transmitted over all RBs (that is, over the entire channel bandwidth) in advance to allow for CQI measurements and enable scheduling of the UEs in RBs with good SINR conditions. The RB bandwidth should be small enough so that sufficient multi-user diversity in the frequency domain is achieved and D-FDMA with comb-shaped spectrum or L-FDMA may be used. Again, multi-user signals can be orthogonal in the frequency domain by using L-FDMA among RBs and possibly further FDMA in the same RB.

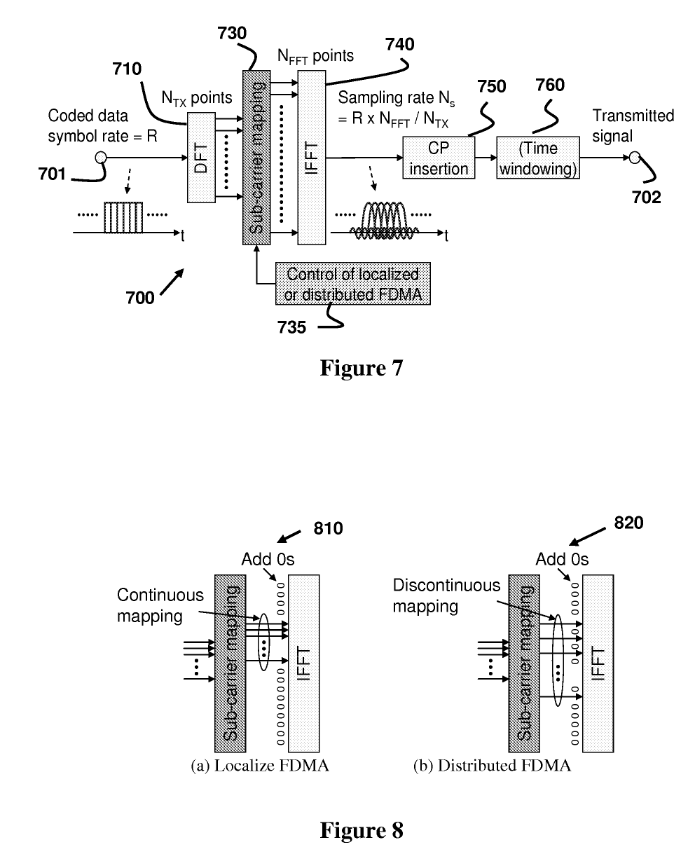

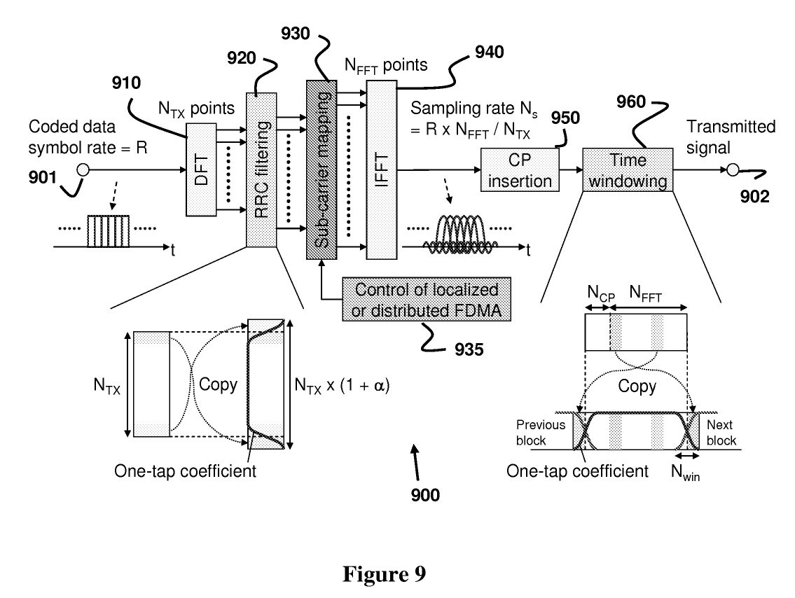

An alternative to IFDMA for realizing SC-FDMA transmission is DFT-spread OFDM with frequency domain processing (depicted in FIG. 7, FIG. 8, and FIG. 9) which is also known as FFT precoded OFDM. DFT-spread OFDM allows for the same radio parameters as those in OFDMA, typically used for DL transmission, such as the maximum sampling frequency and sub-carrier spacing. It may also offer more efficient spectrum utilization.

FIG. 7 illustrates the transmitter block diagram of DFT-spread OFDM with pulse shaping in the time domain where N_{TX} is the DFT size 710, N_{IFFT} is the IFFT size 720, N_{sub} is the number of sub-carriers, R is the symbol rate of coded data sequence, Nₛ is the sampling clock frequency of IFFT and f_{sub} is the sub-carrier spacing.

The mapping relations between FFT and IFFT for L-FDMA and D-FDMA are given in FIG. 7. FIG. 7 includes Discrete Fourier Transform (DFT) 710, sub-carrier mapper 730 with a control block for control of local or distributed FDMA 735, Inverse Fast Fourier Transform (I FFT) 740 CP inserter 750, time windowing 760 L-FDMA and D-FDMA transmissions are realized by mapping the FFT outputs to IFFT inputs corresponding to target RBs. The sub-carrier mapping 730 determines which part of the spectrum that is used for transmission by inserting a suitable number of zeros at the upper and/or lower end in FIG. 8. Between each DFT output sample L−1 zeros are inserted. A mapping with L=1 corresponds to L-FDMA, that is the DFT outputs are mapped to consecutive sub-carriers. With L>1, D-FDMA results and it can be considered as a complement to L-FDMA for additional frequency diversity. Controller 735 provides control of localized or distributed FDMA.

FIG. 8 shows mapping relations between FFT and IFFT for localized and distributed FDMA. By placing a pulse shaping filter between the FFT and the IFFT, SC-FDMA transmission equivalent to the time domain generation can be realized, resulting in identical PAPR and spectral efficiency values. Zero signals 810 and 820 are embedded at the IFFT input for the frequency components where no FFT outputs exist. In this manner, DFT-spread OFDM corresponds to pulse shaping using the raised cosine Nyquist filter with roll-off factor of 0. This results to high PAPR. Then, the difference between IFDMA and DFT-spread OFDM is the use of a roll-off factor greater than 0 or equal to 0 with respect to pulse shaping filtering. SC-FDMA allows for further PAPR reduction though the use of PAPR-reducing modulation or coding schemes, clipping, spectral filtering, etc. For example, frequency-domain spectrum shaping using a certain roll-off can be applied before IFFT (no roll-off corresponds to the filter being transparent). The selection of the roll-off factor is a trade-off between spectrum efficiency and PAPR, i.e., a higher roll-off factor results in a lower PAPR at the cost of spectral efficiency.

By changing the correspondence between the FFT output and the IFFT input as shown in FIG. 6, the bandwidth of each frequency component and its center frequency are changed and both L-FDMA and D-FDMA signals can be produced with the same configuration by changing the parameters.

To achieve the low PAPR of SC-FDMA, the roll-off factor of 0 is necessary in order to reduce the high PAPR in the DFT-spread OFDM. DFT-spread OFDM employing a pulse shaping filter between the FFT and IFFT using the frequency domain processing as shown in FIG. 9 is typically employed. System 900 of FIG. 9 includes Discrete Fourier Transform (DFT) 910, RRC Filter 920, sub-carrier mapper 930 with a control block for control of local or distributed FDMA 935, Inverse Fast Fourier Transform (IFFT) 940 CP inserter 950, time windower 960. The time windower 960 for time windowing and/or FIR filtering after the IFFT 940 is for suppressing the out-of-band emission and satisfy the spectrum mask. Also, some of the IFFT 940 inputs may be unused as a kind of guard sub-carriers in order to limit the bandwidth of the transmitted signal. The structure is practically identical to that of OFDM transmitters except for the additional FFT precoder.

The pilot signal (or reference signal) should provide accurate channel estimation for L-FDMA, accurate channel estimation for D-FDMA and CQI measurements over the entire frequency band. For these reasons, both good narrow-band (L-FDMA) and wide-band (D-FDMA, CQI) characteristics are required. Low PAPR should also be achieved in order to preserve this important property of SC-FDMA for UL transmissions.

The pilot signal should have constant amplitude in the frequency domain to enable accurate channel estimation (flat frequency response). It should also have constant magnitude to maintain the low PAPR property of SC-FDMA. The set of pilot sequences known as Constant Amplitude Zero-Autocorrelation (CAZAC) satisfy the desired pilot properties. An example of CAZAC sequences are given by the following expression:

$${c}_{k} ( n ) = exp [ \frac{j2π k}{L} ( n + n \frac{n + 1}{2} ) ] .$$

In the above formula, L is the length of the CAZAC sequence, n is the index of a particular element of the sequence n={0, 1, 2 . . . , L−1}, and finally, k is the index of the sequence itself. For a given length L, there are L−1 distinct sequences, provided that L is prime. Therefore, the entire family of pilot sequences is defined as k ranges in {1, 2 . . . , L−1}. The above family of pilot sequences is a very special case of Zadoff-Chu family.

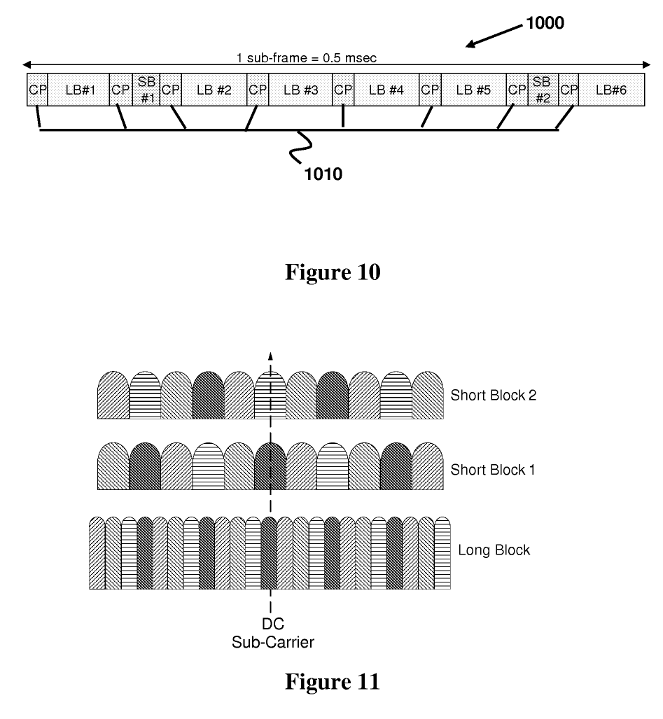

FIG. 10 is a diagram showing sub-frame format with two short blocks and six long blocks per a sub-frame. The basic sub-frame structure 1000 for UL transmissions is given in FIG. 10 using two short blocks (SB#1 and SB#2) and six long blocks (LB#1 to LB#6) per sub-frame 1000. SBs are used for pilot signals to provide coherent demodulation and CQI estimation. The pilot signals can be distributed or localized in nature. LBs are used for control and/or data transmission. Data could include either or both of scheduled based and contention based transmission. Also, the same sub-frame structure is used for both L-FDMA and D-FDMA transmission. CP 1010 is included to achieve UL inter-user orthogonality by enabling efficient frequency-domain equalization at the BS receiver. CP is created in the same usual manner in OFDM by copying the last part of each LB or SB.

The sub-carrier spacing is inversely proportional to the block length. SB length for pilot and LB length for data therefore results in larger sub-carrier spacing for the pilot than the one for the data. When FDE is used for L-FDMA, pilot efficiency for the frequency domain equalizer can always be guaranteed because there is no multiplexing of multi-user data in the same RB, while for D-FDMA, user multiplexing for pilot and for associated data should be done carefully to match with each other and to guarantee the efficiency and accuracy of channel estimation.

The pilot, data, and cyclic prefix fields in FIG. 10 are given as exemplary embodiments. The actual number of samples in each field and the location and number of fields may be varied in different embodiments.

With the same pilot overhead, channel estimation performance for L-FDMA is better than for D-FDMA because in L-FDMA pilot sub-carriers are contiguous. Because the sub-carrier spacing in SBs is wider than that of LBs, interpolation between two pilot symbols in frequency domain is required in case of D-FDMA transmission. As the repetition factor (as for example in FIG. 5) increases, the spacing between pilot symbols also increases. If this spacing becomes larger than the coherent bandwidth, channel estimation error becomes very large. Therefore, the repetition factor for the pilot transmission should typically be smaller than a small integer value (for example, the sub-carrier spacing for the pilot signal should typically be smaller than or equal to 6 for 15 KHz sub-carrier spacing). 2 SBs are enough to provide time interpolation between the pilot and data sub-carriers and enable channel estimation for high mobile speeds for both D-FDMA and L-FDMA.

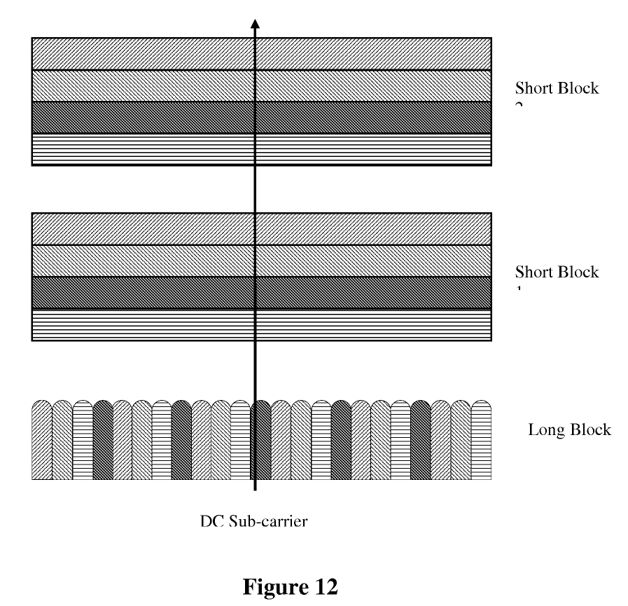

Typical pilot structures are either continuous (repetition factor equals one) or distributed (repetition factor is a small integer larger than one). Multiplexing of continuous and distributed pilots with data are respectively shown in FIGS. 11 and 12.

Accurate channel and CQI estimation are key factors for enabling SC-FDMA (and OFDM) systems to achieve all of their potential performance. Accurate channel estimation is imperative for a satisfactory link performance, while accurate CQI estimation enables frequency dependent scheduling and consequently, system throughput gains. Both channel and CQI estimation are derived from the UL pilot signal.

The relative difference in transmission power between pilot and data signals is therefore an important aspect of the overall system design. Unlike DL transmissions where the BS transmits one or more pilot signals that are common for the reception at all UEs (with the exception of UE-dedicated pilot signals, typically to enable beam-forming), in the UL the pilot signal to data signal power ratio may be adjusted for each UE independently in order to optimize performance.

This invention first examines the conditions under which a difference in the pilot to data signal power ratio is needed and the corresponding values of such difference. Based on performance results, it is suggested that the pilot power is boosted relative to the data under certain conditions that take into account the modulation scheme employed and the UE speed.

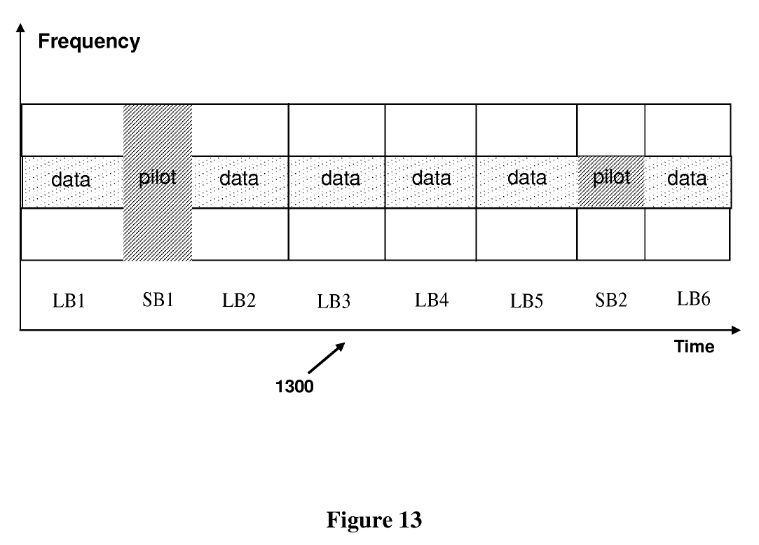

Performance results are presented for the exemplary case that the pilot in SB1 is distributed (D-FDMA) while the pilot is SB2 is localized (L-FDMA). This structure allows good channel estimation for both L-FDMA and D-FDMA data transmission while the distributed pilot in SB1 provides for CQI estimation over the entire frequency band. Data transmission is assumed to be localized (L-FDMA). The examined structure 1300 is depicted in FIG. 13 and the sub-frame duration is assumed to be 0.5 milliseconds. Structure 1300 is comprised of data blocks in long blocks LB1 to LB6 and pilots in short blocks SB1 and SB2. Similar conclusions apply for other combinations of the pilot and data nature (for example if data is D-FDMA and both SB1 and SB2 pilot blocks are also D-FDMA).

When SB1 is distributed, and SB2 is localized, power boost of the pilot signal is applied only to SB1, because channel estimates in SB2 are much more reliable. This is because the transmit power density within SB2 is substantially higher than the transmit power density of SB1. The transmit power boost still gives approximately 0.5 dB gain for high UE speeds (e.g. above 100Kmph). Moreover, only SB1 can provide CQI estimation over the entire frequency band. The present setup in accordance with a preferred embodiment of the invention for the pilot signal (SB1 distributed, SB2 localized) allows for CQI estimation to perform scheduling (SB1 distributed) while maintaining localized pilot power for improved channel estimation (SB2 localized).

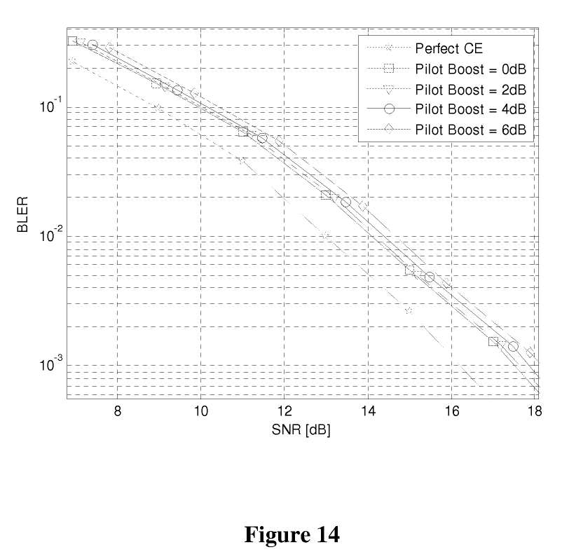

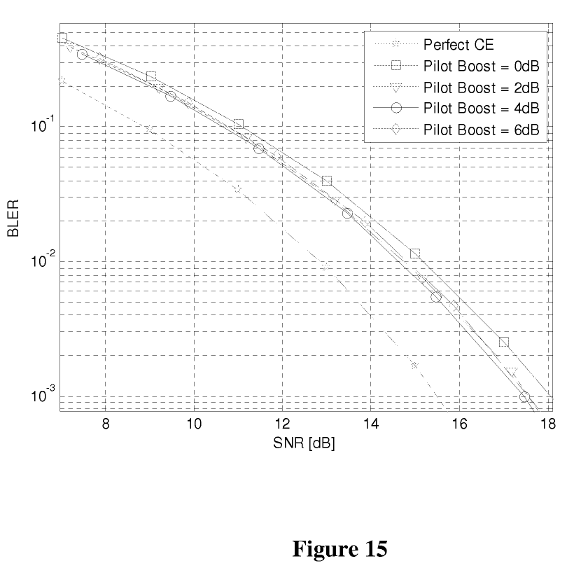

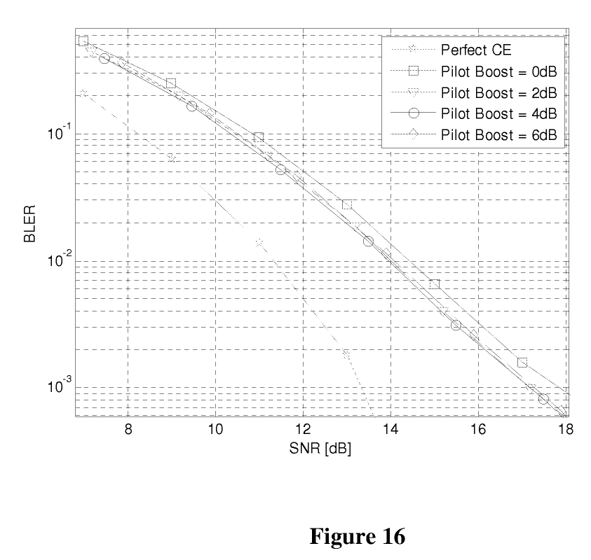

FIG. 14, FIG. 15, and FIG. 16 show the block error rate (BLER) performance for three indicative UE speeds of 3 Kmph, 120 Kmph, and 360 Kmph and 16 QAM modulation. The total UE transmit power in each sub-frame is always the same, implying that when the pilot power is increased (boosted), the data power is decreased by a proportional amount so that the total transmit power is kept constant. Boosting the transmission power of the localized (or distributed) pilot signal gives 0.5-1.0 dB gains for high speed UEs (e.g. UE speed above 100 Kmph). The optimum power boost level is about 4 dB, while a 2 dB power boost achieves near optimum performance. Due to the PAPR considerations, it is preferable to boost the transmit power of the pilot signal of high speed UEs is by 2 dB.

Notice that for low speed UEs, there is a small performance loss with power boosting which, by also taking the PAPR increase for QPSK modulation into account, makes power boosting for low speed UEs undesirable. For similar reasons, power boosting for low speed UEs is not desirable when SB1 and SB2 are of the same nature (distributed or localized) and it is more desirable when the data modulation is QAM16 and only one of the two SBs is distributed (the other being localized). At low UE speeds, time interpolation between SB1 and SB2 is possible, thereby effectively improving the total power available for channel estimation. This is not the case for high UE speeds and boosting the pilot signal power relative to the data signal one becomes beneficial in terms of channel estimation quality and improving overall performance (even though there is reduction in the data signal transmit power in order to satisfy the constraint of same overall transmit power per sub-frame).

Boosting the pilot signal transmission power for high UEs may be through base station (Node B) signaling. Such signaling will be at a very low rate (e.g. lower than UL timing adjustment or slow power control rate). It suffices to use 1 bit (for example, 0 corresponds to no boost and 1 corresponds to 2 dB boost) in the downlink control channel. This would enable to Node B to have more control of the interference generated by the UE's in its sector or cell and may avoid having the transmit power of the data signal be proportionally reduced in response to the increase in the transmit power of the pilot signal. The Node B could also have more information about the pilot signal power used by each UE since it could take into account the previous pilot signal power setting and the probability that the UE has correctly received the pilot signal power adjustment command.

Alternatively, to reduce signaling overhead, the UE may independently decide to boost the pilot signal power based on the Doppler estimate and the modulation method used for data transmission (for example, the UE may not apply pilot signal power boost for QPSK modulation while it may do so for 16 QAM modulation). The UE may or may not decrease the transmit power of the data signal in response to the increase of the transmit power for the data signal.

CQI estimation improvement results are not presented but the increased CQI reliability from the increased transmit pilot power directly leads to system throughput improvements as UE scheduling is more accurate (in terms of the selected modulation and coding scheme and the RBs assigned to transmission).

Many modifications and other embodiments of the invention will come to mind to one skilled in the art to which this invention pertains having the benefit of the teachings presented in the foregoing descriptions, the associated drawings, and claims. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

Alternative Embodiments May Include:

The described method varies the transmit power of some of the pilot fields (SBs) within a TTI or sub-frame without altering the position or number of the pilot fields. An extension of the above scheme is to vary the position and/or number of the pilot fields as well as the power of each pilot field according to the UE velocity, data modulation, and/or other factors. This provides an additional degree of freedom in optimizing the pilot structure at the expense of complexity.

Adjusting the pilot parameters (power, number, position) according to whether closed-loop MIMO, open-loop MIMO, distributed MIMO, transmit diversity, or single antenna transmission is used.

The above embodiments extend to any OFDM-based or multicarrier-based transmission such as OFDMA, discrete Fourier transform (DFT) spread OFDM (SC-FDMA), Walsh-Hadamard transform (WHT) spread OFDM and CDMA.

What is claimed is:

1. A method for boosting pilot signal power relative to data signal power, said method comprising:
obtaining of an user equipment velocity;
determining the transmission power for a plurality of pilot fields with positions in a sub-frame, said determination based on the velocity estimate using a set of pre-computed power values for ranges of velocity; and
performing a sub-frame transmission by applying the determined transmission power to at least a portion of the plurality of pilot fields.

2. The method of claim 1 further comprising:
obtaining of the user equipment modulation scheme;
determining the transmission power for a plurality of pilot fields based on the velocity estimate and modulation scheme using a set of pre-commuted power values for ranges of velocity; and
performing a sub-frame transmission by applying the determined transmission power to at least a portion of the plurality of pilot fields.

3. The method of claim 1 or 2, wherein the total transmission power of the user equipment in each sub-frame is kept constant by decreasing data signal power in a proportional amount to an increase in pilot signal power.

4. The method of claim 3, wherein pilot power is increased if the modulation scheme is 16 QAM modulation.

5. The method of claim 3, wherein the determined transmission power is applied only for distributed pilot signal transmission.

6. The method of claims 1 or 2, further comprising adjusting the position of each of the plurality of pilots within the sub-frame.

7. A method for boosting pilot signal power relative to data signal power in a communication system including a base station and user equipment, said method comprising:
obtaining the user equipment's velocity;
determining the transmission power for a plurality of pilot fields based on the velocity estimate using a set of pre-computed power values for ranges of velocity; and
signaling the user equipment to boost user equipment pilot signal transmission power relative to the data signal transmission power.

8. The method of claim 7, wherein doppler estimation is used to obtain user equipment velocity.

9. The method of claim 7, wherein base station receives a signal from user equipment, said signal providing the user equipment velocity.

10. The methods of claims 1, 2, or 7, wherein the communication system is a single-carrier frequency division multiple access system.

11. A frame structure for boosting pilot signal power relative to data signal power, said structure comprising:
a plurality of long blocks containing data; and
a plurality of short blocks containing pilots

12. The frame structure of claim 11, wherein a first short block is distributed and a second block is localized.

13. The frame structure of claim 11, wherein the plurality of short blocks are distributed.

14. The frame structure of claim 11, wherein the plurality of short blocks are localized.

15. A method for boosting pilot signal power relative to data signal power in an SC-FDMA communication system, said method comprising:
increasing pilot signal power of a sub-frame; and
decreasing data signal power in order to maintain the total transmission power at a pre-determined level.

16. An apparatus for boosting pilot signal power relative to data signal power, said apparatus comprising:
a pilot power signal adjuster for increasing the transmission power for a at least a portion of a plurality of pilot fields; and
a data signal power adjuster for decreasing data signal power in order to maintain the total transmission power at a pre-determined level.

17. User equipment comprising the apparatus of claim 16, further comprising doppler estimator for providing an estimate of the velocity of the user equipment.

18. The user equipment of claim 17, further comprising storage to store a set of pre-computed power values.
